(19) United States
(12) Patent Application Publication
(10) Pub. No.: US 2009/0029857 A1
(43) Pub. Date: Jan. 29, 2009

(54) Synergistic Herbicidal Compositions

(75) Inventors: Giovanni Meazza, Varese (IT); Franco Bettarini, Genova (IT); Luca Fornara, Chieti (IT)

Correspondence Address: HEDMAN & COSTIGAN P.C., 1185 AVENUE OF THE AMERICAS, NEW YORK, NY, 10036, US

(73) Assignee: ISAGRO RICERCA S.R.L., MILANO (IT)

(21) Appl. No.: 12/224,481

(22) PCT Filed: Feb. 26, 2007
(86) PCT No.: PCT/EP2007/001706

§ 371 Date: Oct. 1, 2008

(30) Foreign Application Priority Data
Mar. 6, 2006 (IT) MI2006A 000394

(51) Int. Cl. A01N 43/56; A01N 43/54; A01N 43/40; A01N 43/707; A01N 43/66; A01N 43/653; A01P 3/00

(52) U.S. Cl. 504/134; 504/139; 504/136; 504/130

(57) ABSTRACT

Synergistic compositions are described, having a high herbicidal activity and containing the compound having formula (I): in a mixture with one or more known herbicidal products.

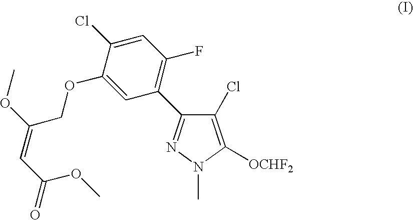

The present invention relates to new herbicidal compositions.

More specifically, the present invention relates to new compositions comprising a particular derivative of 3-methoxy-2-butenoic acid in a synergistic mixture with one or more known herbicides, and the use thereof as herbicides for the control of weeds in agricultural crops.

European patent applications EP 796845 and EP 1020448 describe 3-arylheterocyclic products with a herbicidal activity and the use thereof for the control of weeds in agricultural crops. These documents generically envisage the association of the compounds claimed with other herbicidal products, but no information is provided either as to what the herbicidal compounds suitable for the purpose are, or what are the possible enhancing effects of these compositions compared with the use of 3-arylheterocyclic compounds alone on the herbicidal activity with respect to weeds.

The Applicant has now surprisingly found that when the derivative of 3-methoxy-2-butenoic acid having general formula (I),

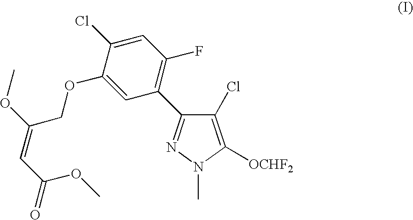

i.e. methyl (E)-4-[2-chloro-5-(4-chloro-5-difluoromethoxy-1-methylpyrazol-3-yl)-4-fluorophenoxy]-3-methoxybut-2-enoate, corresponding to Compound N. 2 of EP1020448, is used in association with at least one of the herbicidal products selected from those specified hereunder, it produces synergistic herbicidal mixtures, i.e. mixtures having a much more enhanced herbicidal activity with respect to weeds compared with what is expected based on the activities of products used separately.

The phytotoxicity with respect to agricultural crops, on the contrary, remains unvaried, or even lower than the expected value, thus allowing considerable advantages to be obtained in the practical use of these mixtures.

An object of the present invention therefore relates to synergistic herbicidal compositions comprising a component [A] and a component [B], wherein the component [A] is the compound having formula (I)

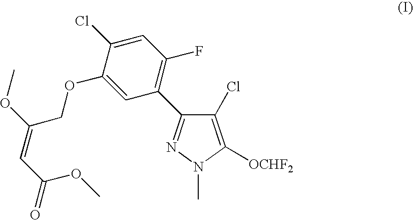

methyl (E)-4-[2-chloro-5-(4-chloro-5-difluoro-methoxy-1-methylpyrazol-3-yl)-4-fluorophenoxy]-3-methoxy-but-2-enoate, and component [B] consists of at least one product selected from the following herbicides
[1] acetochlor (2-chloro-N-(ethoxymethyl)-N-(2-ethyl-6-methylphenyl)acetamide);
[2] alachlor (2-chloro-N-(2,6-diethylphenyl)-N-(methoxymethyl)acetamide);
[3] amidosulfuron (N-[[[[(4,6-dimethoxy-2-pyrimidinyl)-amino]carbonyl]amino]sulfonyl]-N-methylmethanesulfonamide);
[4] atrazine (6-chloro-N-ethyl-N′-(1-methylethyl)-1,3,5-triazine-2,4-diamine);
[5] beflubutamid (2-[4-fluoro-3-(trifluoromethyl)-phenoxy]-N-(phenylmethyl)butanamide);
[6] bensulfuron-methyl (methyl [[[[[(4,6-dimethoxy-2-pyrimidinyl)amino]carbonyl]amino]sulfonyl]methyl]-benzoate);
[7] bispyribac-sodium (sodium 2,6-bis[(4,6-dimethoxy-2-pyrimidinyl)oxy]benzoate);
[8] bromoxynil (3,5-dibromo-4-hydroxybenzonitrile);
[9] chlorimuron-ethyl (ethyl [[[[(4-chloro-6-methoxy-2-pyrimidinyl)amino]carbonyl]amino]sulfonyl]benzoate;
[10] chlorotoluron (N′-(3-chloro-4-methylphenyl)-N,N-dimethylurea);
[11] chlorsulfuron (2-chloro-N-[[(4-methoxy-6-methyl-1,3,5-triazin-2-yl)amino]carbonyl]benzenesulfonamide);
[12] clodinafop-propargyl (propynyl (R)-2-[4-[(5-chloro-3-fluoro-2-pyridinyl)oxy]phenoxy]propanoate);
[13] clomazone (2-[(2-chlorophenyl)methyl]-4,4-dimethyl-3-isoxazolidinone;
[14] diflufenican (N-(2,4-difluorophenyl)-2-[3-(trifluoromethyl)phenoxy]-3-pyridinecarboxamide);
[15] dimethenamid ((RS)-2-chloro-N-(2,4-dimethyl-3-thienyl)-N-(2-methoxy-1-methylethyl)acetamide);
[16] diuron (N′-(3,4-dichlorophenyl)-N,N-dimethylurea);
[17]ethoxysulfuron (1-(4,6-dimethoxypyrimidin-2-yl)-3-(ethoxyphenoxysulfonyl)urea);
[18] fenoxaprop-P ((R)-2-[4-[(6-chloro-2-benzoxazolyl)-oxy]phenoxy]propanoic acid) and its ethyl ester;
[19] flufenacet (N-(4-fluorophenyl)-N-(1-methylethyl)-2-[[5-(trifluoromethyl)-1,3,4-thiadiazol-2-yl]oxy]-acetamide);
[20] fluometuron (N,N-dimethyl-N′-[3-(trifluoromethyl)-phenyl]urea;
[21] fluoroxypyr ([4(4-amino-3,5-dichloro-6-fluoro-2-pyridinyl)oxy]acetic acid);
[22] glufosinate (ammonium (±)-2-amino-4-(hydroxymethyl-phosphinyl)butanoate);
[23] glyphosate (N-(phosphonomethyl)glycine) and its salts;
[24] halosulfuron (3-chloro-5-[[[[(4,6-dimethoxy-2-pyrimidinyl)amino]carbonyl]amino]sulfonyl]-1-methyl-1H-pyrazole-4-carboxylic acid) and its methyl ester;
[25] imazamox (2-[4,5-dihydro-4-methyl-4-(1-methylethyl)-5-oxo1H-imidazol-2-yl]-5-(methoxymethyl)-3-pyridinecarboxylic acid;
[26] ioxynil (4-hydroxy-3,5-diiodobenzonitrile);
[27] isoproturon (N,N-dimethyl-N′-[4-(1-methylethyl)-phenyl]urea);
[28] isoxaflutole ((5-cyclopropyl-4-isoxazolyl)-[2-(methylsulfonyl)-4-(trifluoromethyl)phenyl]methanone);
[29] linuron (N′-(3,4-dichlorophenyl)-N-methoxy-N-methyl-urea);
[30] MCPA ((4-chloro-2-methylphenoxy)acetic acid) and its thioethyl ester;
[31] MCPB (4-(4-chloro-2-methylphenoxy)butanoic acid);
[32] mesotrione (2-[4-(methylsulfonyl)-2-nitrobenzoyl]-1,3-cyclohexandione);
[33] metolachlor (2-chloro-N-(2-ethyl-6-methylphenyl)-N-(2-methoxy-1-methylethyl)acetamide);
[34] S-metolachlor (mixture of two enantiomers of metolachlor, containing 80-100% of 2-chloro-N-(2-ethyl-6-methylphenyl)-N-[(1S)-2-methoxy-1-methylethyl]-acetamide);
[35] metribuzin (4-amino-6-(1,1-dimethylethyl)-3-(methyl-thio)-1,2,4-triazin-5(4H)-one);
[36] metsulfuron-methyl (methyl 2-[[[[(4-methoxy-6-methyl-1,3,5-triazin-2-yl)amino]carbonyl]amino]-sulfonyl]-benzoate);
[37] MSMA (monosodium methyl arsonate);
[38] orthosulfamuron (2-[[[[[(4,6-dimethoxy-2-pyrimidin-yl)amino]carbonyl]amino]sulfonyl]amino-N,N-dimethyl-benzamide);
[39] pendimethalin (N-(1-ethylpropyl)-3,4-dimethyl-2,6-dinitrobenzenamine);
[40] penoxsulam (2-(2,2-difluoroethoxy)-N-(5,8-dimethoxy)
[1,2,4]triazolo[1,5-c]pyrimidin-2-yl)-6-(trifluoromethyl)benzenesulfonamide);
[41] pethoxamid (2-chloro-N-(2-ethoxyethyl)-N-(2-methyl-1-phenyl-1-propenyl)acetamide);
[42] picolinafen (N-(4-fluorophenyl)-6-[3-(trifluoro-methyl)phenoxy]-2-pyridinecarboxamide);
[43] pinoxaden (8-(2,6-diethyl-4-methylphenyl)-1,2,4,5-tetrahydro-7-oxo-7H-pyrazolo[1,2-d][1,4,5]oxadiazepin-9-yl 2,2-dimethylpropanoate);
[44] prometryn (N,N′-bis(1-methylethyl)-6-(methylthio)-1,3,5-triazine-2,4-diamine;
[45] propachlor (2-chloro-N-(methylethyl)-N-phenyl-acetamide);
[46] propanil (N-(3,4-dichlorophenyl)propanamide);
[47] propoxycarbazone (methyl 2-[[[(4,5-dihydro-4-methyl-5-oxo-3-propoxy-1H-1,2,4-triazol-1-yl)carbonyl]amino]-sulfonyl]benzoate);
[48] sulcotrione (2-[2-chloro-4-(methylsulfonyl)-benzoyl]-1,3-cyclohexanedione);
[49]sulfosulfuron (N-[[(4,6-dimethoxy-2-pyrimidinyl)-amino]carbonyl]-2-(ethylsulfonyl)imidazo[1,2-a]pyridin-3-sulfonamide);
[50] terbuthylazine (6-chloro-N-(1,1-dimethylethyl)-N′-ethyl-1,3,5-triazine-2,4-diamine);
[51] thifensulfuron-methyl (methyl 3-[[[[(4-methoxy-6-methyl-1,3,5-triazin-2-yl)amino]carbonyl]amino]sulfonyl]-2-thiophenecarboxylate);
[52] triasulfuron (2-(2-chloroethoxy)-N-[[(4-methoxy-6-methyl-1,3,5-triazin-2-yl)amino]carbonyl]benzenesulfon-amide);
[53] tribenuron-methyl (methyl 2-[[[[(4-methoxy-6-methyl-1,3,5-triazin-2-yl)methylamino]carbonyl]amino]-sulfonyl]benzoate);
[54] trifloxysulfuron (N-[[(4,6-dimethoxy-2-pyrimidin-2-yl)amino]carbonyl]-3-(2,2,2-trifluoroethoxy)-2-pyridine-sulfonamide);
[55] trifluralin (2,6-dinitro-N,N-dipropyl-4-(trifluoro-methyl)benzeneamine).

An object of the present invention also relates to the use of synergistic herbicidal compositions comprising a component [A] and a component [B], wherein component [A] is the compound having formula (I)

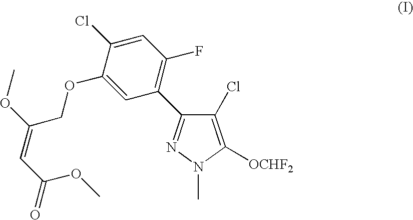

methyl (E)-4-[2-chloro-5-(4-chloro-5-difluoro-methoxy-1-methylpyrazol-3-yl)-4-fluorophenoxy]-3-methoxy-but-2-enoate, and component [B] consists of at least one product selected from the following herbicides:
[1]acetochlor (2-chloro-N-(ethoxymethyl)-N-(2-ethyl-6-methylphenyl)acetamide);
[2] alachlor (2-chloro-N-(2,6-diethylphenyl)-N-(methoxy-methyl)acetamide);
[3] amidosulfuron (N-[[[[(4,6-dimethoxy-2-pyrimidinyl)-amino]carbonyl]amino]sulfonyl]-N-methylmethanesulfonamide);
[4] atrazine (6-chloro-N-ethyl-N′-(1-methylethyl)-1,3,5-triazine-2,4-diamine);
[5] beflubutamid (2-[4-fluoro-3-(trifluoromethyl)-phenoxy]-N-(phenylmethyl)butanamide);
[6] bensulfuron-methyl (methyl [[[[[(4,6-dimethoxy-2-pyrimidinyl)amino]carbonyl]amino]sulfonyl]methyl]-benzoate);
[7] bispyribac-sodium (sodium 2,6-bis[(4,6-dimethoxy-2-pyrimidinyl)oxy]benzoate);
[8] bromoxynil (3,5-dibromo-4-hydroxybenzonitrile);
[9] chlorimuron-ethyl (ethyl [[[[(4-chloro-6-methoxy-2-pyrimidinyl)amino]carbonyl]amino]sulfonyl]benzoate;
[10] chlorotoluron (N′-(3-chloro-4-methylphenyl)-N,N-dimethylurea);
[11] chlorsulfuron (2-chloro-N-[[(4-methoxy-6-methyl-1,3,5-triazin-2-yl)amino]carbonyl]benzenesulfonamide);
[12] clodinafop-propargyl (propynyl (R)-2-[4-[(5-chloro-3-fluoro-2-pyridinyl)oxy]phenoxy]propanoate);
[13] clomazone (2-[(2-chlorophenyl)methyl]-4,4-dimethyl-3-isoxazolidinone;
[14] diflufenican (N-(2,4-difluorophenyl)-2-[3-(trifluoromethyl)phenoxy]-3-pyridinecarboxamide);
[15] dimethenamid ((RS)-2-chloro-N-(2,4-dimethyl-3-thienyl)-N-(2-methoxy-1-methylethyl)acetamide);
[16] diuron (N′-(3,4-dichlorophenyl)-N,N-dimethylurea);
[17]ethoxysulfuron (1-(4,6-dimethoxypyrimidin-2-yl)-3-(ethoxyphenoxysulfonyl)urea);
[18] fenoxaprop-P ((R)-2-[4-[(6-chloro-2-benzoxazolyl)-oxy]phenoxy]propanoic acid) and its ethyl ester;
[19] flufenacet (N-(4-fluorophenyl)-N-(1-methylethyl)-2-[[5-(trifluoromethyl)-1,3,4-thiadiazol-2-yl]oxy]-acetamide);
[20] fluometuron (N,N-dimethyl-N′-[3-(trifluoromethyl)-phenyl]urea;
[21] fluoroxypyr ([4(4-amino-3,5-dichloro-6-fluoro-2-pyridinyl)oxy]acetic acid);
[22] glufosinate (ammonium (±)-2-amino-4-(hydroxymethyl-phosphinyl)butanoate);
[23] glyphosate (N-(phosphonomethyl)glycine) and its salts;
[24] halosulfuron (3-chloro-5-[[[[(4,6-dimethoxy-2-pyrimidinyl)amino]carbonyl]amino]sulfonyl]-1-methyl-1H-pyrazole-4-carboxylic acid) and its methyl ester;
[25] imazamox (2-[4,5-dihydro-4-methyl-4-(1-methylethyl)-5-oxo1H-imidazol-2-yl]-5-(methoxymethyl)-3-pyridinecarboxylic acid;
[26] ioxynil (4-hydroxy-3,5-diiodobenzonitrile);
[27] isoproturon (N,N-dimethyl-N′-[4-(1-methylethyl)-phenyl]urea);
[28] isoxaflutole ((5-cyclopropyl-4-isoxazolyl)-[2-(methylsulfonyl)-4-(trifluoromethyl)phenyl]methanone);
[29] linuron (N′-(3,4-dichlorophenyl)-N-methoxy-N-methyl-urea);
[30] MCPA ((4-chloro-2-methylphenoxy)acetic acid) and its thioethyl ester;
[31] MCPB (4-(4-chloro-2-methylphenoxy)butanoic acid);
[32] mesotrione (2-[4-(methylsulfonyl)-2-nitrobenzoyl]-1,3-cyclohexandione);
[33] metolachlor (2-chloro-N-(2-ethyl-6-methylphenyl)-N-(2-methoxy-1-methylethyl)acetamide);
[34] S-metolachlor (mixture of two enantiomers of metolachlor, containing 80-100% of 2-chloro-N-(2-ethyl-6-methylphenyl)-N-[(1S)-2-methoxy-1-methylethyl]-acetamide);
[35] metribuzin (4-amino-6-(1,1-dimethylethyl)-3-(methyl-thio)-1,2,4-triazin-5(4H)-one);
[36] metsulfuron-methyl (methyl 2-[[[[(4-methoxy-6-methyl-1,3,5-triazin-2-yl)amino]carbonyl]amino]-sulfonyl]-benzoate);
[37] MSMA (monosodium methyl arsonate);
[38] orthosulfamuron (2-[[[[[(4,6-dimethoxy-2-pyrimidin-yl)amino]carbonyl]amino]sulfonyl]amino-N,N-dimethyl-benzamide);
[39] pendimethalin (N-(1-ethylpropyl)-3,4-dimethyl-2,6-dinitrobenzenamine);
[40] penoxsulam (2-(2,2-difluoroethoxy)-N-(5,8-dimethoxy) [1,2,4]triazolo[1,5-c]pyrimidin-2-yl)-6-(trifluoromethyl)benzenesulfonamide);
[41] pethoxamid (2-chloro-N-(2-ethoxyethyl)-N-(2-methyl-1-phenyl-1-propenyl)acetamide);
[42] picolinafen (N-(4-fluorophenyl)-6-[3-(trifluoro-methyl)phenoxy]-2-pyridinecarboxamide);
[43] pinoxaden (8-(2,6-diethyl-4-methylphenyl)-1,2,4,5-tetrahydro-7-oxo-7H-pyrazolo[1,2-d][1,4,5]oxadiazepin-9-yl 2,2-dimethylpropanoate);
[44] prometryn (N,N′-bis(1-methylethyl)-6-(methylthio)-1,3,5-triazine-2,4-diamine;
[45] propachlor (2-chloro-N-(methylethyl)-N-phenyl-acetamide);
[46] propanil (N-(3,4-dichlorophenyl)propanamide);
[47] propoxycarbazone (methyl 2-[[[(4,5-dihydro-4-methyl-5-oxo-3-propoxy-1H-1,2,4-triazol-1-yl)carbonyl]amino]-sulfonyl]benzoate);
[48] sulcotrione (2-[2-chloro-4-(methylsulfonyl)-benzoyl]-1,3-cyclohexanedione);
[49]sulfosulfuron (N-[[(4,6-dimethoxy-2-pyrimidinyl)-amino]carbonyl]-2-(ethylsulfonyl)imidazo[1,2-a]pyridin-3-sulfonamide);
[50] terbuthylazine (6-chloro-N-(1,1-dimethylethyl)-N′-ethyl-1,3,5-triazine-2,4-diamine);
[51] thifensulfuron-methyl (methyl 3-[[[[(4-methoxy-6-methyl-1,3,5-triazin-2-yl)amino]carbonyl]amino]sulfonyl]-2-thiophenecarboxylate);
[52] triasulfuron (2-(2-chloroethoxy)-N-[[(4-methoxy-6-methyl-1,3,5-triazin-2-yl)amino]carbonyl]benzenesulfonamide);
[53] tribenuron-methyl (methyl 2-[[[[(4-methoxy-6-methyl-1,3,5-triazin-2-yl)methylamino]carbonyl]amino]-sulfonyl]benzoate);
[54] trifloxysulfuron (N-[[(4,6-dimethoxy-2-pyrimidin-2-yl)amino]carbonyl]-3-(2,2,2-trifluoroethoxy)-2-pyridine-sulfonamide);
[55] trifluralin (2,6-dinitro-N,N-dipropyl-4-(trifluoromethyl)benzeneamine);
   for the control of weeds in agricultural crops.

In particular, component [B] is preferably selected from bromoxynil, diflufenican, flufenacet, glyphosate, ioxynil, isoproturon, mesotrione, S-metolachlor.

Component [A], a compound having formula (I), can be prepared according to the method described in EP1020448 and as specified in detail in Example 1 described below.

The components [B] are known commercial products or products in the commercialization phase and are therefore indicated with their common ISO (International Standard Organization) name and with the chemical names according to Chemical Abstracts. The structural formulae of these products, as also the main applications as herbicides are specified, among others, in “The Pesticide Manual” 13^{a} edition (2003), Ed. C. D. S. Tomlin, published by the British Crop Protection Council, Farnham (UK). Compound [35] (orthosulfamuron) is described in international patent application WO 98/40361.

As already mentioned, the use of the herbicidal compositions, object of the present invention, is particularly advantageous with respect to the use of the single components [A] and [B] as, in addition to having a wider action range, reduced dosages of the products can be adopted for obtaining the same herbicidal effect; the compositions according to the present invention are effective in the post-emergence and pre-emergence control of numerous monocotyledonous and dicotyledonous weeds. At the same time, said compositions have a reduced or zero phytotoxicity with respect to important agricultural crops thus making their use possible in the selective control of weeds. When required, the compositions can also be used as total herbicides, in relation to the quantity of active principles adopted.

Examples of weeds which can be effectively controlled using the compositions of the present invention are: Abutilon theophrasti, Adonis spp., Ambrosia spp., Alisma plantago, Amaranthus spp., Amni maius, Anagallis arvensis, Anthemis spp., Aphanes arvensis, Atriplex patula, Bidens pilosa, Capsella bursa-pastoris, Chenopodium album, Convolvulus sepium, Datura stramonium, Euphorbia spp., Fumaria officinalis, Galeopsis tetrahit, Galinsoga ciliata, Galium aparine, Geranium spp., Helianthus spp., Ipomea spp., Kochia scoparia, Lamium spp., Matricaria spp., Monochoria vaginalis, Myosotis arvensis, Papaver rhoeas, Phaseolus aureus, Polygonum spp., Portulaca oleracea, Raphanus raphanistrum, Rumex crispus, Senecio vulgaris, Sesbania exaltata, Sida spinosa, Sinapis arvensis, Solanum nigrum, Sonchus spp., Stellaria media, Thlaspi arvense, Veronica spp., Vicia spp., Viola spp., Xanthium spp., Aegilops tauschii, Alopecurus myosuroides, Apera spp., Avena fatua, Brachiaria spp., Bromus spp., Cenchrus echinatus, Commelina bengalensis, Cynodon dactilon, Cyperus spp., Digitaria spp., Echinocloa spp., Eleusine indica, Elymus repens, Eragrostis pilosa, Eriochloa villosa, Fimbristylis spp., Heleocaris avicularis, Heteranthera spp., Leptochloa spp., Lolium spp., Panicum spp., Phalaris spp., Poa spp., Scirpus spp., Setaria viridis, Sorghum spp.

Examples of agrarian crops which can be advantageously treated with the compositions of the invention are: wheat (Triticum sp.), barley (Hordeum vulgare), maize (Zea mays), soybean (Glycine max), rice (Oryza sativa), cotton (Gossypium hirsutum), sugarcane (Saccharum officinarum).

In the herbicidal compositions, object of the present invention, components [A] and [B] defined above can be mixed within a very wide ratio, in relation to various factors such as, for example: the component(s) [B] selected, the weeds to be attacked, the degree of infestation, the climatic conditions, the characteristics of the soil, the application method.

In general, the ratio between the weight quantity of component [A] and the weight quantity of the component(s) [B], can vary from 1:0,1 to 1:10,000, preferably from 1:1 to 1:1,000.

For practical use in agriculture, the herbicidal compositions, object of the present invention, can be applied in such quantities as to guarantee applicative dosages of compound (I) within the range of 0, 5-200 g/ha, preferably 1-100 g/ha, and applicative dosages of the component(s) [B] within the range of 1-10,000 g/ha, preferably 10-5,000 g/ha.

A further object of the present invention relates to a method for the control of weeds in cultivated areas by applying the compositions described above.

For practical use in agriculture, it is often advantageous to adopt the herbicidal compositions, object of the present invention, in the form of suitable formulations which can be already prepared or obtained at the moment of use. This can be effected either by formulating component [A] together with component(s) [B] in the desired ratio, to give the final composition, or by preparing the composition at the moment of use by mixing the relative quantities of component [A] and component(s) [B], formulated separately.

Compositions can be used in the form of dry powders, wettable powders, emulsifying concentrates, micro-emulsions, pastes, granulates, solutions, suspensions, etc.: the choice of the type of composition will depend on the specific use.

The compositions are prepared according to known methods, for example by diluting or dissolving the active substance with a solvent medium and/or solid diluent, optionally in the presence of surface-active agents.

Inert solid diluents or supports which can be used are: kaolin, alumina, silica, talc, bentonite, gypsum, quartz, dolomite, attapulgite, montmorillonites, diatomaceous earth, cellulose, starch, etc.

Inert liquid diluents which can be used are water, or organic solvents such as aromatic hydrocarbons (xylols, alkylbenzol mixtures, etc.), aliphatic hydrocarbons (hexane, cyclohexane, etc.), halogenated aromatic hydrocarbons (chlorobenzol, etc.), alcohols (methanol, propanol, butanol, octanol, etc.), esters (isobutyl acetate, etc.), ketones (acetone, cyclohexanone, acetophenone, isophorone, ethylamylketone, etc.), or vegetable or mineral oils and mixtures thereof, etc.

Surface-active agents which can be used are wetting and emulsifying agents of the non-ionic type (polyethoxylated alkylphenols, polyethoxylated fatty alcohols, etc.), of the anionic type (alkylbenzenesulfonates, alkylsulfonates, etc.), of the cationic type (quaternary salts of alkylammonium, etc.).

It is also possible to add dispersing agents (for example lignin and its salts, cellulose derivatives, alginates, etc.), stabilizers (for example antioxidants, ultraviolet-ray absorbers, etc.).

In order to widen the action range of the above compositions, it is possible to add other active ingredients such as, for example, other herbicides, antidotes, fungicides, insecticides, acaricides, fertilizers, etc.

Examples of other herbicides which can be added to the compositions, object of the invention, are: acifluorfen, aclonifen, AKH-7088, ametryn, amicarbazone, amitrole, anilofos, asulam, azafenidin, azimsulfuron, aziprotryne, BAY MKH 6561, benazolin, benfluralin, benfuresate, bensulide, bentazone, benzfendizone, benzobicyclon, benzofenap, benzthiazuron, bifenox, bilanafos, bromacil, bromobutide, bromofenoxim, butachlor, butafenacil, butamifos, butenachlor, butralin, butroxydim, butylate, cafenstrole, carbetamide, carfentrazone-ethyl, chlomethoxyfen, chloramben, chlorbromuron, chlorbufam, chlorflurenol, chloridazon, chlornitrofen, chloroxuron, chlorpropham, chlorthal, chlorthiamid, cinidon ethyl, cinmethylin, cinosulfuron, clethodim, clomeprop, clopyralid, cloransulam-methyl, cumyluron (JC-940), cyanazine, cycloate, cyclosulfamuron, cycloxydim, cyhalofop-butyl, 2,4-D, 2,4-DB, daimuron, dalapon, desmedipham, desmetryn, dicamba, dichlobenil, dichlorprop, dichlorprop-P, diclofop, diclosulam, diethatyl, difenoxuron, difenzoquat, diflufenzopyr, dimefuron, dimepiperate, dimethachlor, dimethametryn, dinitramine, dinoseb, dinoseb acetate, dinoterb, diphenamid, dipropetryn, diquat, dithiopyr, 1-diuron, eglinazine, endothal, EPTC, esprocarb, ethalfluralin, ethametsulfuron-methyl, ethidimuron, ethiozin (SMY 1500), ethofumesate, ethoxyfen-ethyl (HC-252), etobenzanid (HW 52), fentrazamide, fenuron, flamprop, flamprop-M, flazasulfuron, florasulam, fluazifop, fluazifop-P, fluazolate (JV 485), flucarbazone-sodium, fluchloralin, flufenpyr ethyl, flumetsulam, flumiclorac-pentyl, flumioxazin, flumipropin, fluoroglycofen, fluoronitrofen, flupoxam, flupropanate, flupyrsulfuron, flurenol, fluridone, fluorochloridone, flurtamone, fluthiacet-methyl, fomesafen, foramsulfuron, fosamine, furyloxyfen, haloxyfop, haloxyfop-P-methyl, hexazinone, imazamethabenz, imazapic, imazapyr, imazaquin, imazethapyr, imazosulfuron, indanofan, iodosulfuron, isopropalin, isouron, isoxaben, isoxachlortole, isoxapyrifop, KPP-421, lactofen, lenacil, LS830556, mecoprop, mecoprop-P, mefenacet, mesosulfuron, metamitron, metazachlor, methabenzthiazuron, methazole, methoprotryne, methyldymron, metobenzuron, metobromuron, metosulam, metoxuron, molinate, monalide, monolinuron, naproanilide, napropamide, naptalam, NC-330, neburon, nicosulfuron, nipyraclofen, norflurazon, orbencarb, oryzalin, oxadiargyl, oxadiazon, oxasulfuron, oxaziclomefone, oxyfluorfen, paraquat, pebulate, pentanochlor, pentoxazone, phenmedipham, picloram, piperophos, pretilachlor, primisulfuron, prodiamine, profluazol, proglinazine, prometon, propaquizafop, propazine, propham, propisochlor, propyzamide, prosulfocarb, prosulfuron, pyraclonil, pyraflufen-ethyl, pyrazogyl (HSA-961), pyrazolynate, pyrazosulfuron, pyrazoxyfen, pyribenzoxim, pyributicarb, pyridafol, pyridate, pyriftalid, pyriminobacmethyl, pyrithiobac-sodium, quinclorac, quinmerac, quizalofop, quizalofop-P, rimsulfuron, sethoxydim, siduron, simazine, simetryn, sulfentrazone, sulfometuron-methyl, 2,3,6-TBA, TCA-sodium, tebutam, tebuthiuron, tepraloxydim, terbacil, terbumeton, terbutryn, thenylchlor, thiazafluoron, thiazopyr, thidiazimin, thiobencarb, tiocarbazil, tioclorim, tralkoxydim, triallate, triaziflam, triclopyr, trietazine, triflusulfuron-methyl, tritosulfuron, UBI-C4874, vernolate.

The concentration of active substances [A]+[B], in the above compositions can vary within a wide range, depending on the active principles selected, the applications for which they are destined, the environmental conditions and the type of formulation. The overall composition of active substances can generally range from 1 to 90%, preferably from 5 to 75%.

The following examples are provided for a better illustration of the invention.

### EXAMPLE 1

Preparation of methyl (E)-4-[2-chloro-5-(4-chloro-5-difluoromethoxy-1-methylpyrazol-3-yl)-4-fluorophenoxy]-3-methoxybut-2-enoate (component [A]).

14 g (101 mmoles) of potassium carbonate are added to a solution of 32.71 g (100 mmoles) of 4-chloro-3-[4-chloro-2-fluoro-5-hydroxyphenyl]-5-difluoromethoxy-1-methylpyrazole in 300 ml of N,N-dimethyl-formamide (DMF). The mixture is kept under stirring at room temperature for 30 minutes.

A solution of 18 g (109 mmoles) of methyl (E)-4-chloro-3-methoxy-2-butenoate in 30 ml of DMF is dripped into the suspension; at the end of the addition, the reaction mixture is heated to 50° C. for 4 hours.

At the end of the reaction, the mixture is diluted with water (2 litres) and extracted with methylene chloride (3×0.5 litres). The extract is washed to neutrality with water, anhydrified with sodium sulfate; the organic solvent is then removed by distillation under vacuum and the raw product is purified by chromatography on a silica gel column, eluting with hexane/ethyl acetate 65:35. 35 g of a dense oil are obtained, which solidifies after a few days giving a white product with a melting point of 66-69° C.

¹H-NMR (CDCl₃): δ 3,68 (s, 3H); 3,71 (s, 3H); 3,82 (s, 3H); 5,20 (s, 1H); 5,28 (s, 2H); 6,69 (t, 1H); 7,16 (d, 1H aromatic); 7,21 (d, 1H aromatic).

¹⁹F-NMR (CDCl₃): δ a −121,1 (m, 1F); −81,4 (d, 2F).

### EXAMPLE 2

### a) Determination of the Herbicidal Activity and Phytotoxicity in Post-Emergence

The herbicidal activity in post-emergence of the compositions of the invention was evaluated according to the following operating procedures.

The vegetable species of interest (weeds or crops) were planted in vases having an upper diameter of 10 cm, a height of 10 cm and containing sandy earth.

Water was added to each vase in a suitable quantity for the germination of the seeds. The vases were then divided into four groups for each weed or crop.

Fifteen days after planting (ten in the case of wheat), i.e. when the weed seedlings and crops, depending on the species, had reached a height of 10-15 cm, the first group of vases was treated with a hydroacetone dispersion containing acetone at 10% by volume, Tween 20 at 0.5%, and component [A] at a dosage D_{A}.

The second group was treated with a hydroacetone dispersion containing acetone at 10% by volume, Tween 20 at 0.5%, and component [B] at a dosage D_{B}.

The third group was treated with a hydroacetone dispersion containing acetone at 10% by volume, Tween 20 at 0.5%, and the composition C according to the present invention, containing components [A] and [B] at dosages, D_{A} and D_{B}, respectively.

The fourth group was treated with a hydroacetone solution only, containing acetone at 10% by volume and Tween 20 at 0.5%, and was used as a comparative reference (blank).

All the vases were kept under observation in a conditioned environment under the following environmental conditions:

temperature: 24° C.;

relative humidity: 60%;

photo-period: 16 ore;

light intensity: 10,000 lux.

Every two days the vases were uniformly watered to ensure a sufficient humidity degree for a good growth of the plants.

Fifteen days after treatment, the herbicidal activity was evaluated (expressed as a % of the damage observed on the vegetable species) for the composition C (E_{C}) and for the two components [A] and [B] tested separately (E_{A}, E_{B}).

Weeds tested were: Abutilon theophrasti, Amaranthus retroflexus, Amni maius, Capsella bursa pastoris, Chenopodium album, Convolvulus sepium, Galium aparine, Geranium dissectum, Ipomea purpurea, Matricaria chamomilla, Papaver rhoeas, Polygonum persicaria, Portulaca oleracea, Sida spinosa, Stellaria media, Veronica persica, Viola arvensis, Xanthium italicum, Alopecurus myosuroides, Avena fatua, Digitaria sanguinalis, Echinochloa crus galli, Panicum dicothomiflorum, Setaria viridis, Sorgum halepense.

Crops tested were: wheat, barley, maize, soybean, rice, cotton.

### b) Determination of the Herbicidal Activity and Phytotoxicity in Pre-Emergence

The herbicidal activity in pre-emergence of the compounds of the invention was evaluated according to the following operating procedures.

The vegetable species of interest (weeds or crops) were planted in vases having an upper diameter of 10 cm, a height of 10 cm and containing sandy earth.

Water was added to each vase in a suitable quantity for the germination of the seeds. The vases were then divided into four groups for each weed or crop.

One day after planting, the first group of vases was treated with a hydroacetone dispersion containing acetone at 10% by volume, Tween 20 at 0.5%, and component [A] at a dosage D_{A}.

The second group was treated with a hydroacetone dispersion containing acetone at 10% by volume, Tween 20 at 0.5%, and component [B] at a dosage D_{B}.

The third group was treated with a hydroacetone dispersion containing acetone at 10% by volume, Tween 20 at 0.5%, and the composition C according to the present invention, containing components [A] and [B] at dosages, D_{A} e D_{B}, respectively.

The fourth group was treated with a hydroacetone solution only, containing acetone at 10% by volume and Tween 20 at 0.5%, and was used as a comparative reference (blank).

All the vases were kept under observation in a conditioned environment under the following environmental conditions:

temperature: 24° C.;

relative humidity: 60%;

photo-period: 16 ore;

light intensity: 10,000 lux.

Every two days the vases were uniformly watered to ensure a sufficient humidity degree for a good growth of the plants.

Four weeks after treatment, the herbicidal activity was evaluated (expressed as a % of the damage observed on the vegetable species) for the composition (E_{C}) and for the two components [A] and [B] tested separately (E_{A}, E_{B}).

Weeds tested were: Abutilon theophrasti, Amaranthus retroflexus, Amni maius, Capsella bursa pastoris, Chenopodium album, Convolvulus sepium, Galium aparine, Geranium dissectum, Ipomea purpurea, Matricaria chamomilla, Papaver rhoeas, Polygonum persicaria, Portulaca oleracea, Sida spinosa, Stellaria media, Veronica persica, Viola arvensis, Xanthium italicum, Alopecurus myosuroides, Avena fatua, Digitaria sanguinalis, Echinochloa crus galli, Panicum dicothomiflorum, Setaria viridis, Sorgum halepense.

Crops tested were: wheat, barley, maize, soybean, rice, cotton.

For both the post-emergence and pre-emergence treatment, a synergistic effect was observed each time the experimental herbicidal activity of the composition, E_{C}, proved to be higher than that calculated applying the Colby formula (“Weeds”, 15 (1967), pages 20-22):

Eₜₑₒᵣ=E_{A}+E_{B}−E_{A}×E_{B}/100

wherein:
Eₜₑₒᵣ=activity calculated for the composition consisting of [A] at a dosage D_{A}+[B] at a dosage D_{B};
E_{A}=activity observed for [A] at a dosage D_{A};
E_{B}=activity observed for [B] at a dosage D_{B}.

In Table are reported the compositions for which a remarkable synergistic effect (E_{C}/Eₜₑₒᵣ>1,10) against some important weeds in post-emergence or pre-emergence treatments, was observed.

TABLE

| | COMPONENTS [A] + [B] | Rates g ai/ha | |
|---|---|---|---|
| COMPOSITION | (TYPE OF APPLICATION) | [A] | [B] |
| C1 | [A] + acetochlor (PRE) | 50 | 900 |
| C2 | [A] + alachlor (PRE) | 50 | 760 |
| C3 | [A] + amidosulfuron (POST) | 10 | 10 |
| C4 | [A] + atrazine (PRE) | 50 | 760 |
| C5 | [A] + beflubutamid (POST) | 12.5 | 85 |
| C6 | [A] + bensulfuron (POST) | 15 | 30 |
| C7 | [A] + bispyribac-Na (POST) | 15 | 25 |
| C8 | [A] + bromoxynil (POST) | 15 | 105 |
| C9 | [A] + chlorimuron (POST) | 15 | 10 |
| C10 | [A] + chlorotoluron (POST) | 15 | 750 |
| C11 | [A] + chlorsulfuron (PRE) | 40 | 13 |
| C12 | [A] + clodinafop (POST) | 12.5 | 30 |
| C13 | [A] + clomazone (POST) | 15 | 150 |
| C14 | [A] + diflufenican (POST) | 12.5 | 75 |
| C15 | [A] + dimethenamid (PRE) | 75 | 360 |
| C16 | [A] + diuron (PRE) | 100 | 750 |
| C17 | [A] + ethoxysulfuron (POST) | 15 | 30 |
| C18 | [A] + fenoxaprop (POST)) | 20 | 35 |
| C19 | [A] + flufenacet (PRE | 40 | 40 |
| C20 | [A] + fluometuron (POST) | 15 | 560 |
| C21 | [A] + fluroxypyr (POST) | 15 | 500 |
| C22 | [A] + glufosinate (PRE) | 75 | 230 |
| C23 | [A] + glyphosate (PRE) | 100 | 360 |
| C24 | [A] + halosulfuron (POST) | 12.5 | 35 |
| C25 | [A] + imazamox (POST) | 12.5 | 17 |
| C26 | [A] + ioxynil (POST) | 15 | 125 |
| C27 | [A] + isoproturon (PRE) | 50 | 750 |
| C28 | [A] + isoxaflutole (PRE) | 50 | 30 |
| C29 | [A] + linuron (PRE) | 50 | 300 |
| C30 | [A] + MCPA (POST) | 15 | 250 |
| C31 | [A] + MCPB (POST) | 15 | 500 |
| C32 | [A] + mesotrione (PRE) | 50 | 75 |
| C33 | [A] + metolachlor (PRE) | 75 | 900 |
| C34 | [A] + S-metolachlor (PRE) | 75 | 480 |
| C35 | [A] + metribuzin (PRE) | 40 | 100 |
| C36 | [A] + metsulfuron (POST) | 12.5 | 2 |
| C37 | [A] + MSMA (POST) | 15 | 1400 |
| C38 | [A] + orthosulfamuron (POST) | 12.5 | 37.5 |
| C39 | [A] + pendimethalin (PRE) | 40 | 650 |
| C40 | [A] + penoxsulam(POST) | 12.5 | 20 |
| C41 | [A] + pethoxamid (PRE) | 100 | 600 |
| C42 | [A] + picolinafen (POST) | 12.5 | 37.5 |
| C43 | [A] + pinoxaden (POST) | 25 | 35 |
| C44 | [A] + prometryn (PRE) | 50 | 500 |
| C45 | [A] + propachlor (PRE) | 40 | 1600 |
| C46 | [A] + propanil (POST) | 20 | 1800 |
| C47 | [A] + propoxycarbazone (POST) | 12.5 | 21 |
| C48 | [A] + sulcotrione (PRE) | 50 | 150 |
| C49 | [A] + sulfosulfuron (POST) | 12.5 | 12.5 |
| C50 | [A] + terbuthylazine (PRE) | 50 | 500 |
| C51 | [A] + thifensulfuron (POST) | 12.5 | 5 |
| C52 | [A] + triasulfuron (POST) | 12.5 | 5 |
| C53 | [A] + tribenuron (POST) | 12.5 | 7.5 |
| C54 | [A] + trifloxysulfuron(POST) | 15 | 5 |
| C55 | [A] + trifluralin (PRE) | 50 | 140 |

1. Synergistic herbicidal compositions comprising a component [A] and a component [B], wherein the component [A] is the compound having formula (I) 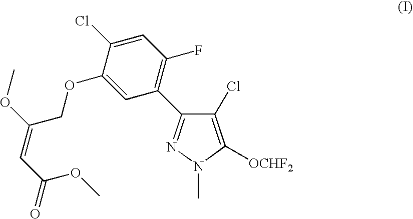
methyl (E)-4-[2-chloro-5-(4-chloro-5-difluoro-methoxy-1-methylpyrazol-3-yl)-4-fluorophenoxy]-3-methoxy-but-2-enoate, and component [B] consists of at least one product selected from the following herbicides:
[1] acetochlor (2-chloro-N-(ethoxymethyl)-N-(2-ethyl-6-methylphenyl)acetamide);
[2] alachlor (2-chloro-N-(2,6-diethylphenyl)-N-(methoxymethyl)acetamide);
[3] amidosulfuron (N-[[[[(4,6-dimethoxy-2-pyrimidinyl)-amino]carbonyl]amino]sulfonyl]-N-methylmethanesulfonamide);
[4] atrazine (6-chloro-N-ethyl-N′-(1-methylethyl)-1,3,5-triazine-2,4-diamine);
[5] beflubutamid (2-[4-fluoro-3-(trifluoromethyl)-phenoxy]-N-(phenylmethyl)butanamide);
[6] bensulfuron-methyl (methyl [[[[[(4,6-dimethoxy-2-pyrimidinyl)amino]carbonyl]amino]sulfonyl]methyl]-benzoate);
[7] bispyribac-sodium (sodium 2,6-bis[(4,6-dimethoxy-2-pyrimidinyl)oxy]benzoate);
[8] bromoxynil (3,5-dibromo-4-hydroxybenzonitrile);
[9] chlorimuron-ethyl (ethyl [[[[(4-chloro-6-methoxy-2-pyrimidinyl)amino]carbonyl]amino]sulfonyl]benzoate;
[10] chlorotoluron (N′-(3-chloro-4-methylphenyl)-N,N-dimethylurea);
[11] chlorsulfuron (2-chloro-N-[[(4-methoxy-6-methyl-1,3,5-triazin-2-yl)amino]carbonyl]benzenesulfonamide);
[12] clodinafop-propargyl (propynyl (R)-2-[4-[(5-chloro-3-fluoro-2-pyridinyl)oxy]phenoxy]propanoate);
[13] clomazone (2-[(2-chlorophenyl)methyl]-4,4-dimethyl-3-isoxazolidinone;
[14] diflufenican (N-(2,4-difluorophenyl)-2-[3-(trifluoromethyl)phenoxy]-3-pyridinecarboxamide);
[15] dimethenamid ((RS)-2-chloro-N-(2,4-dimethyl-3-thienyl)-N-(2-methoxy-1-methylethyl)acetamide);
[16] diuron (N′-(3,4-dichlorophenyl)-N,N-dimethylurea);
[17] ethoxysulfuron (1-(4,6-dimethoxypyrimidin-2-yl)-3-(ethoxyphenoxysulfonyl)urea);
[18] fenoxaprop-P ((R)-2-[4-[(6-chloro-2-benzoxazolyl)-oxy]phenoxy]propanoic acid) and its ethyl ester;
[19] flufenacet (N-(4-fluorophenyl)-N-(1-methylethyl)-2-[[5-(trifluoromethyl)-1,3,4-thiadiazol-2-yl]oxy]-acetamide);
[20] fluometuron (N,N-dimethyl-N′-[3-(trifluoromethyl)-phenyl]urea;
[21] fluoroxypyr ([4(4-amino-3,5-dichloro-6-fluoro-2-pyridinyl)oxy]acetic acid);
[22] glufosinate (ammonium (±)-2-amino-4-(hydroxymethyl-phosphinyl)butanoate);
[23] glyphosate (N-(phosphonomethyl)glycine) and its salts;
[24] halosulfuron (3-chloro-5-[[[[(4,6-dimethoxy-2-pyrimidinyl)amino]carbonyl]amino]sulfonyl]-1-methyl-1H-pyrazole-4-carboxylic acid) and its methyl ester;
[25] imazamox (2-[4,5-dihydro-4-methyl-4-(1-methylethyl)-5-oxo1H-imidazol-2-yl]-5-(methoxymethyl)-3-pyridinecarboxylic acid;
[26] ioxynil (4-hydroxy-3,5-diiodobenzonitrile);
[27] isoproturon (N,N-dimethyl-N′-[4-(1-methylethyl)-phenyl]urea);
[28] isoxaflutole ((5-cyclopropyl-4-isoxazolyl)-[2-(methylsulfonyl)-4-(trifluoromethyl)phenyl]methanone);
[29] linuron (N′-(3,4-dichlorophenyl)-N-methoxy-N-methyl-urea);
[30] MCPA ((4-chloro-2-methylphenoxy)acetic acid) and its thioethyl ester;
[31] MCPB (4-(4-chloro-2-methylphenoxy)butanoic acid);
[32] mesotrione (2-[4-(methylsulfonyl)-2-nitrobenzoyl]-1,3-cyclohexandione);
[33] metolachlor (2-chloro-N-(2-ethyl-6-methylphenyl)-N-(2-methoxy-1-methylethyl)acetamide);
[34] S-metolachlor (mixture of two enantiomers of metolachlor, containing 80-100% of 2-chloro-N-(2-ethyl-6-methylphenyl)-N-[(1S)-2-methoxy-1-methylethyl]-acetamide);
[35] metribuzin (4-amino-6-(1,1-dimethylethyl)-3-(methylthio)-1,2,4-triazin-5(4H)-one);
[36] metsulfuron-methyl (methyl 2-[[[[(4-methoxy-6-methyl-1,3,5-triazin-2-yl)amino]carbonyl]amino]-sulfonyl]-benzoate);
[37] MSMA (monosodium methyl arsonate);
[38] orthosulfamuron (2-[[[[[(4,6-dimethoxy-2-pyrimidin-yl)amino]carbonyl]amino]sulfonyl]amino-N,N-dimethyl-benzamide);
[39] pendimethalin (N-(1-ethylpropyl)-3,4-dimethyl-2,6-dinitrobenzenamine);
[40] penoxsulam (2-(2,2-difluoroethoxy)-N-(5,8-dimethoxy) [1,2,4]triazolo[1,5-c]pyrimidin-2-yl)-6-(trifluoromethyl)benzenesulfonamide);
[41] pethoxamid (2-chloro-N-(2-ethoxyethyl)-N-(2-methyl-1-phenyl-1-propenyl)acetamide);
[42] picolinafen (N-(4-fluorophenyl)-6-[3-(trifluoromethyl)phenoxy]-2-pyridinecarboxamide);
[43] pinoxaden (8-(2,6-diethyl-4-methylphenyl)-1,2,4,5-tetrahydro-7-oxo-7H-pyrazolo[1,2-d][1,4,5]oxadiazepin-9-yl 2,2-dimethylpropanoate);
[44] prometryn (N,N′-bis(1-methylethyl)-6-(methylthio)-1,3,5-triazine-2,4-diamine;
[45] propachlor (2-chloro-N-(methylethyl)-N-phenyl-acetamide);
[46] propanil (N-(3,4-dichlorophenyl)propanamide);
[47] propoxycarbazone (methyl 2-[[[(4,5-dihydro-4-methyl-5-oxo-3-propoxy-1H-1,2,4-triazol-1-yl)carbonyl]amino]-sulfonyl]benzoate);
[48] sulcotrione (2-[2-chloro-4-(methylsulfonyl)-benzoyl]-1,3-cyclohexanedione);
[49] sulfosulfuron (N-[[(4,6-dimethoxy-2-pyrimidinyl)-amino]carbonyl]-2-(ethylsulfonyl)imidazo[1,2-a]pyridin-3-sulfonamide);
[50] terbuthylazine (6-chloro-N-(1,1-dimethylethyl)-N′-ethyl-1,3,5-triazine-2,4-diamine);
[51] thifensulfuron-methyl (methyl 3-[[[[(4-methoxy-6-methyl-1,3,5-triazin-2-yl)amino]carbonyl]amino]sulfonyl]-2-thiophenecarboxylate);
[52] triasulfuron (2-(2-chloroethoxy)-N-[[(4-methoxy-6-methyl-1,3,5-triazin-2-yl)amino]carbonyl]benzenesulfonamide);
[53] tribenuron-methyl (methyl 2-[[[[(4-methoxy-6-methyl-1,3,5-triazin-2-yl)methylamino]carbonyl]amino]-sulfonyl]benzoate);
[54] trifloxysulfuron (N-[[(4,6-dimethoxy-2-pyrimidin-2-yl)amino]carbonyl]-3-(2,2,2-trifluoroethoxy)-2-pyridine-sulfonamide);
[55] trifluralin (2,6-dinitro-N,N-dipropyl-4-(trifluoromethyl)benzeneamine).

2. The synergistic herbicidal compositions according to claim 1, characterized in that component [B] is selected from bromoxynil, diflufenican, flufenacet, glyphosate, ioxynil, isoproturon, mesotrione, S-metolachlor.

3. The synergistic herbicidal compositions according to claim 1, characterized in that the weight quantity of component [A] is such as to ensure applicative dosages of the compound (I) ranging from 0,5 to 200 g/ha.

4. The synergistic herbicidal compositions according to claim 3, characterized in that the applicative dosages of the compound (I) range from 1 to 100 g/ha.

5. The synergistic herbicidal compositions according to claim 1, characterized in that the applicative dosages of the component(s) [B] range from 1 to 10,000 g/ha.

6. The synergistic herbicidal compositions according to claim 5, characterized in that the applicative dosages of the component(s) [B] range from 10 to 5,000 g/ha.

7. The synergistic herbicidal compositions according to claim 1, characterized in that weight ratio between the quantity of component [A] and the quantity of component(s) [B] ranges from 1:0.1 to 1:10,000.

8. The synergistic herbicidal compositions according to claim 7, characterized in that the weight ratio ranges from 1:1 to 1:1,000.

9. The synergistic herbicidal compositions according to claim 1, characterized in that they consist of formulations in the form of dry powders, wettable powders, emulsifying concentrates, micro-emulsions, pastes, granulates, solutions, suspensions.

10. The synergistic herbicidal compositions according to claim 9, characterized in that they consist of formulations already prepared containing component [A] and component(s) [B], in the desired ratio, or obtained at the moment of use by mixing the relative quantities of component [A] and component(s) [B], formulated separately.

11. The synergistic herbicidal compositions according to claim 1, characterized in that they also contain further active substances such as, for example, other herbicides, antidotes, fungicides, insecticides, acaricides, fertilizers, etc.

12. The synergistic herbicidal compositions according to claim 11, characterized in that the further herbicides are selected from:
acifluorfen, aclonifen, AKH-7088, ametryn, amicarbazone, amitrole, anilofos, asulam, azafenidin, azimsulfuron, aziprotryne, BAY MKH 6561, benazolin, benfluralin, benfuresate, bensulide, bentazone, benzfendizone, benzobicyclon, benzofenap, benzthiazuron, bifenox, bilanafos, bromacil, bromobutide, bromofenoxim, butachlor, butafenacil, butamifos, butenachlor, butralin, butroxydim, butylate, cafenstrole, carbetamide, carfentrazone-ethyl, chlomethoxyfen, chloramben, chlorbromuron, chlorbufam, chlorflurenol, chloridazon, chlornitrofen, chloroxuron, chlorpropham, chlorthal, chlorthiamid, cinidon ethyl, cinmethylin, cinosulfuron, clethodim, clomeprop, clopyralid, cloransulam-methyl, cumyluron (JC-940), cyanazine, cycloate, cyclosulfamuron, cycloxydim, cyhalofop-butyl, 2,4-D, 2,4-DB, daimuron, dalapon, desmedipham, desmetryn, dicamba, dichlobenil, dichlorprop, dichlorprop-P, diclofop, diclosulam, diethatyl, difenoxuron, difenzoquat, diflufenzopyr, dimefuron, dimepiperate, dimethachlor, dimethametryn, dinitramine, dinoseb, dinoseb acetate, dinoterb, diphenamid, dipropetryn, diquat, dithiopyr, 1-diuron, eglinazine, endothal, EPTC, esprocarb, ethalfluralin, ethametsulfuron-methyl, ethidimuron, ethiozin (SMY 1500), ethofumesate, ethoxyfen-ethyl (HC-252), etobenzanid (HW 52), fentrazamide, fenuron, flamprop, flamprop-M, flazasulfuron, florasulam, fluazifop, fluazifop-P, fluazolate (JV 485), flucarbazone-sodium, fluchloralin, flufenpyr ethyl, flumetsulam, flumiclorac-pentyl, flumioxazin, flumipropin, fluoroglycofen, fluoronitrofen, flupoxam, flupropanate, flupyrsulfuron, flurenol, fluridone, fluorochloridone, flurtamone, fluthiacet-methyl, fomesafen, foramsulfuron, fosamine, furyloxyfen, haloxyfop, haloxyfop-P-methyl, hexazinone, imazamethabenz, imazapic, imazapyr, imazaquin, imazethapyr, imazosulfuron, indanofan, iodosulfuron, isopropalin, isouron, isoxaben, isoxachlortole, isoxapyrifop, KPP-421, lactofen, lenacil, LS830556, mecoprop, mecoprop-P, mefenacet, mesosulfuron, metamitron, metazachlor, methabenzthiazuron, methazole, methoprotryne, methyldymron, metobenzuron, metobromuron, metosulam, metoxuron, molinate, monalide, monolinuron, naproanilide, napropamide, naptalam, NC-330, neburon, nicosulfuron, nipyraclofen, norflurazon, orbencarb, oryzalin, oxadiargyl, oxadiazon, oxasulfuron, oxaziclomefone, oxyfluorfen, paraquat, pebulate, pentanochlor, pentoxazone, phenmedipham, picloram, piperophos, pretilachlor, primisulfuron, prodiamine, profluazol, proglinazine, prometon, propaquizafop, propazine, propham, propisochlor, propyzamide, prosulfocarb, prosulfuron, pyraclonil, pyraflufen-ethyl, pyrazogyl (HSA-961), pyrazolynate, pyrazosulfuron, pyrazoxyfen, pyribenzoxim, pyributicarb, pyridafol, pyridate, pyriftalid, pyriminobacmethyl, pyrithiobac-sodium, quinclorac, quinmerac, quizalofop, quizalofop-P, rimsulfuron, sethoxydim, siduron, simazine, simetryn, sulfentrazone, sulfometuron-methyl, 2,3,6-TBA, TCA-sodium, tebutam, tebuthiuron, tepraloxydim, terbacil, terbumeton, terbutryn, thenylchlor, thiazafluoron, thiazopyr, thidiazimin, thiobencarb, tiocarbazil, tioclorim, tralkoxydim, triallate, triaziflam, triclopyr, trietazine, triflusulfuron-methyl, tritosulfuron, UBI-C4874, vernolate.

13. The synergistic herbicidal compositions according to claim 11, characterized in that the concentration of active substances, also comprising [A]+[B], ranges from 1 to 90%.

14. The synergic herbicidal compositions according to claim 13, characterized in that the concentration ranges from 5 to 75%.

15. Use of synergistic herbicidal compositions comprising a component [A] and a component [B], wherein the component [A] is the compound having formula (I) 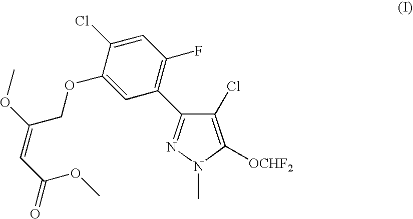
methyl (E)-4-[2-chloro-5-(4-chloro-5-difluoro-methoxy-1-methylpyrazol-3-yl)-4-fluorophenoxy]-3-methoxy-but-2-enoate, and component [B] consists of at least one product selected from the following herbicides:
[1] acetochlor (2-chloro-N-(ethoxymethyl)-N-(2-ethyl-6-methylphenyl)acetamide);
[2] alachlor (2-chloro-N-(2,6-diethylphenyl)-N-(methoxymethyl)acetamide);
[3] amidosulfuron (N-[[[[(4,6-dimethoxy-2-pyrimidinyl)-amino]carbonyl]amino]sulfonyl]-N-methylmethanesulfonamide);
[4] atrazine (6-chloro-N-ethyl-N′-(1-methylethyl)-1,3,5-triazine-2,4-diamine);
[5] beflubutamid (2-[4-fluoro-3-(trifluoromethyl)-phenoxy]-N-(phenylmethyl)butanamide);
[6] bensulfuron-methyl (methyl [[[[[(4,6-dimethoxy-2-pyrimidinyl)amino]carbonyl]amino]sulfonyl]methyl]-benzoate);
[7] bispyribac-sodium (sodium 2,6-bis[(4,6-dimethoxy-2-pyrimidinyl)oxy]benzoate);
[8] bromoxynil (3,5-dibromo-4-hydroxybenzonitrile);
[9] chlorimuron-ethyl (ethyl [[[[(4-chloro-6-methoxy-2-pyrimidinyl)amino]carbonyl]amino]sulfonyl]benzoate;
[10] chlorotoluron (N′-(3-chloro-4-methylphenyl)-N,N-dimethylurea);
[11] chlorsulfuron (2-chloro-N-[[(4-methoxy-6-methyl-1,3,5-triazin-2-yl)amino]carbonyl]benzenesulfonamide);
[12] clodinafop-propargyl (propynyl (R)-2-[4-[(5-chloro-3-fluoro-2-pyridinyl)oxy]phenoxy]propanoate);
[13] clomazone (2-[(2-chlorophenyl)methyl]-4,4-dimethyl-3-isoxazolidinone;
[14] diflufenican (N-(2,4-difluorophenyl)-2-[3-(trifluoromethyl)phenoxy]-3-pyridinecarboxamide);
[15] dimethenamid ((RS)-2-chloro-N-(2,4-dimethyl-3-thienyl)-N-(2-methoxy-1-methylethyl)acetamide);
[16] diuron (N′-(3,4-dichlorophenyl)-N,N-dimethylurea);
[17] ethoxysulfuron (1-(4,6-dimethoxypyrimidin-2-yl)-3-(ethoxyphenoxysulfonyl)urea);
[18] fenoxaprop-P ((R)-2-[4-[(6-chloro-2-benzoxazolyl)-oxy]phenoxy]propanoic acid) and its ethyl ester;
[19] flufenacet (N-(4-fluorophenyl)-N-(1-methylethyl)-2-[[5-(trifluoromethyl)-1,3,4-thiadiazol-2-yl]oxy]-acetamide);
[20] fluometuron (N,N-dimethyl-N′-[3-(trifluoromethyl)-phenyl]urea;
[21] fluoroxypyr ([4(4-amino-3,5-dichloro-6-fluoro-2-pyridinyl)oxy]acetic acid);
[22] glufosinate (ammonium (±)-2-amino-4-(hydroxymethyl-phosphinyl)butanoate);
[23] glyphosate (N-(phosphonomethyl)glycine) and its salts;
[24] halosulfuron (3-chloro-5-[[[[(4,6-dimethoxy-2-pyrimidinyl)amino]carbonyl]amino]sulfonyl]-1-methyl-1H-pyrazole-4-carboxylic acid) and its methyl ester;
[25] imazamox (2-[4,5-dihydro-4-methyl-4-(1-methylethyl)-5-oxo1H-imidazol-2-yl]-5-(methoxymethyl)-3-pyridinecarboxylic acid;
[26] ioxynil (4-hydroxy-3,5-diiodobenzonitrile);
[27] isoproturon (N,N-dimethyl-N′-[4-(1-methylethyl)-phenyl]urea);
[28] isoxaflutole ((5-cyclopropyl-4-isoxazolyl)-[2-(methylsulfonyl)-4-(trifluoromethyl)phenyl]methanone);
[29] linuron (N′-(3,4-dichlorophenyl)-N-methoxy-N-methyl-urea);
[30] MCPA ((4-chloro-2-methylphenoxy)acetic acid) and its thioethyl ester;
[31] MCPB (4-(4-chloro-2-methylphenoxy)butanoic acid);
[32] mesotrione (2-[4-(methylsulfonyl)-2-nitrobenzoyl]-1,3-cyclohexandione);
[33] metolachlor (2-chloro-N-(2-ethyl-6-methylphenyl)-N-(2-methoxy-1-methylethyl)acetamide);
[34] S-metolachlor (mixture of two enantiomers of metolachlor, containing 80-100% of 2-chloro-N-(2-ethyl-6-methylphenyl)-N-[(1S)-2-methoxy-1-methylethyl]-acetamide);
[35] metribuzin (4-amino-6-(1,1-dimethylethyl)-3-(methylthio)-1,2,4-triazin-5(4H)-one);
[36] metsulfuron-methyl (methyl 2-[[[[(4-methoxy-6-methyl-1,3,5-triazin-2-yl)amino]carbonyl]amino]-sulfonyl]-benzoate);
[37] MSMA (monosodium methyl arsonate);
[38] orthosulfamuron (2-[[[[[(4,6-dimethoxy-2-pyrimidin-yl)amino]carbonyl]amino]sulfonyl]amino-N,N-dimethyl-benzamide);
[39] pendimethalin (N-(1-ethylpropyl)-3,4-dimethyl-2,6-dinitrobenzenamine);
[40] penoxsulam (2-(2,2-difluoroethoxy)-N-(5,8-dimethoxy) [1,2,4]triazolo[1,5-c]pyrimidin-2-yl)-6-(trifluoromethyl)benzenesulfonamide);
[41] pethoxamid (2-chloro-N-(2-ethoxyethyl)-N-(2-methyl-1-phenyl-1-propenyl)acetamide);
[42] picolinafen (N-(4-fluorophenyl)-6-[3-(trifluoro-methyl)phenoxy]-2-pyridinecarboxamide);
[43] pinoxaden (8-(2,6-diethyl-4-methylphenyl)-1,2,4,5-tetrahydro-7-oxo-7H-pyrazolo[1,2-d][1,4,5]oxadiazepin-9-yl 2,2-dimethylpropanoate);
[44] prometryn (N,N′-bis(1-methylethyl)-6-(methylthio)-1,3,5-triazine-2,4-diamine;
[45] propachlor (2-chloro-N-(methylethyl)-N-phenyl-acetamide);
[46] propanil (N-(3,4-dichlorophenyl)propanamide);
[47] propoxycarbazone (methyl 2-[[[(4,5-dihydro-4-methyl-5-oxo-3-propoxy-1H-1,2,4-triazol-1-yl)carbonyl]amino]-sulfonyl]benzoate);
[48] sulcotrione (2-[2-chloro-4-(methylsulfonyl)-benzoyl]-1,3-cyclohexanedione);
[49] sulfosulfuron (N-[[(4,6-dimethoxy-2-pyrimidinyl)-amino]carbonyl]-2-(ethylsulfonyl)imidazo[1,2-a]pyridin-3-sulfonamide);
[50] terbuthylazine (6-chloro-N-(1,1-dimethylethyl)-N′-ethyl-1,3,5-triazine-2,4-diamine);
[51] thifensulfuron-methyl (methyl 3-[[[[(4-methoxy-6-methyl-1,3,5-triazin-2-yl)amino]carbonyl]amino]sulfonyl]-2-thiophenecarboxylate);
[52] triasulfuron (2-(2-chloroethoxy)-N-[[(4-methoxy-6-methyl-1,3,5-triazin-2-yl)amino]carbonyl]benzenesulfonamide);
[53] tribenuron-methyl (methyl 2-[[[[(4-methoxy-6-methyl-1,3,5-triazin-2-yl)methylamino]carbonyl]amino]sulfonyl]benzoate);
[54] trifloxysulfuron (N-[[(4,6-dimethoxy-2-pyrimidin-2-yl)amino]carbonyl]-3-(2,2,2-trifluoroethoxy)-2-pyridine-sulfonamide);
[55] trifluralin (2,6-dinitro-N,N-dipropyl-4-(trifluoromethyl)benzeneamine) for the control of weeds in agricultural crops.

16. Use of the synergistic herbicidal compositions according to claim 2, for the control of weeds in agricultural crops.

17. Use according to claim 15 for the control, in both post-emergence and in pre-emergence, of monocotyledonous and dicotyledonous weeds and/or for the treatment of agricultural crops.

18. Use according to claim 15 for the control of Abutilon theophrasti, Adonis spp., Ambrosia spp., Alisma plantago, Amaranthus spp., Amni maius, Anagallis arvensis, Anthemis spp., Aphanes arvensis, Atriplex patula, Bidens pilosa, Capsella bursa-pastoris, Chenopodium album, Convolvulus sepium, Datura stramonium, Euphorbia spp., Fumaria officinalis, Galeopsis tetrahit, Galinsoga ciliata, Galium aparine, Geranium spp., Helianthus spp., Ipomea spp., Kochia scoparia, Lamium spp., Matricaria spp., Monochoria vaginalis, Myosotis arvensis, Papaver rhoeas, Phaseolus aureus, Polygonum spp., Portulaca oleracea, Raphanus raphanistrum, Rumex crispus, Senecio vulgaris, Sesbania exaltata, Sida spinosa, Sinapis arvensis, Solanum nigrum, Sonchus spp., Stellaria media, Thlaspi arvense, Veronica spp., Vicia spp., Viola spp., Xanthium spp., Aegilops tauschii, Alopecurus myosuroides, Apera spp., Avena fatua, Brachiaria spp., Bromus spp., Cenchrus echinatus, Commelina bengalensis, Cynodon dactilon, Cyperus spp., Digitaria spp., Echinocloa spp., Eleusine indica, Elymus repens, Eragrostis pilosa, Eriochloa villosa, Fimbristylis spp., Heleocaris avicularis, Heteranthera spp., Leptochloa spp., Lolium spp., Panicum spp., Phalaris spp., Poa spp., Scirpus spp., Setaria viridis, Sorghum spp.

19. Use according to claim 15 for the treatment of wheat (Triticum sp.), barely (Hordeum vulgare), maize (Zea mays), soybean (Glycine max), rice (Oryza sativa), cotton (Gossypium hirsutum), sugarcane (Saccharum officinarum).

20. A method for the control of weeds in cultivated areas by means of the application of synergistic herbicidal compositions according to claim 1.
